(19) United States
(12) Patent Application Publication
(10) Pub. No.: US 2021/0300791 A1
(43) Pub. Date: Sep. 30, 2021

(54) ULTRAVIOLET LIGHT-EMITTING FAUCET

(71) Applicants: Miaoyun HUANG, Visalia, CA (US); DAWNWAY ENTERPRISE CO., LTD., Taichung City (TW)

(72) Inventor: Wen-Shun HUANG, Taichung City (TW)

(21) Appl. No.: 16/828,139

(22) Filed: Mar. 24, 2020

(51) Int. Cl. C02F 1/32; E03C 1/04

(52) U.S. Cl. CPC C02F 1/325; E03C 1/04; C02F 2303/04; C02F 2307/06; C02F 2201/3228; C02F 2201/3224

(57) ABSTRACT

An ultraviolet light-emitting faucet includes an inlet assembly, an outlet assembly, an operation assembly, a water-proof light-emitting module and a light guide. The operation assembly includes a conduit for connecting an inlet channel of the inlet assembly to an outlet channel of the outlet assembly. The conduit includes a cave, an optical channel, and an operation chamber including a first open end in communication with the cave and a second open end in communication with the optical channel. The water-proof light-emitting module is located in the cave and operable to cast ultraviolet light and visible light into the operation chamber through the first open end of the operation chamber. The visible light further goes into the optical channel through the second open end of the operation chamber. The light guide is supported on the operation assembly and operable to guide the visible light out of the optical channel.

### BACKGROUND OF INVENTION

### 1. Field of Invention

The present invention relates to a faucet and, more particularly, to an ultraviolet light-emitting faucet.

### 2. Related Prior Art

To ensure security of potable water. A faucet can be equipped with an ultraviolet light-emitting module for sterilization of potable water. For example, CN109667982A and CN205479692U both disclose an ultraviolet light-emitting faucet.

### SUMMARY OF INVENTION

It is the primary objective of the present invention to provide an ultraviolet light-emitting faucet.

To achieve the foregoing objective, the ultraviolet light-emitting faucet includes an inlet assembly, an outlet assembly, an operation assembly, a water-proof light-emitting module and a light guide. The inlet assembly includes an inlet channel. The outlet assembly includes an outlet pipe. The operation assembly includes a conduit for connecting the inlet channel to the outlet channel. The conduit includes an interconnecting channel, a cave, an optical channel and an operation chamber. The cave is in communication with the interconnecting channel. The operation chamber includes a first open end in communication with the cave and a second open end in communication with the optical channel. The water-proof light-emitting module is located in the cave and operable to cast ultraviolet light and visible light into the operation chamber through the first open end of the operation chamber of the operation assembly. The visible light further goes into the optical channel through the second open end of the operation chamber of the operation assembly. The light guide is supported on the operation assembly and operable to guide the visible light out of the optical channel.

In another aspect, the water-proof light-emitting module includes a water-proof shell, a circuit board located in the water-proof shell, and a bundle of cables that is connected to the circuit board and extends out of the water-proof shell. The water-proof shell includes an optical exit aligned with the first open end of the operation chamber. The circuit board includes an ultraviolet light-emitting diode for emitting the ultraviolet light and a visible light light-emitting diode for emitting the visible light. The ultraviolet light and the visible light go out of the water-proof shell through the optical exit.

In another aspect, the operation chamber is spherical.

In another aspect, the interconnecting channel of the operation assembly is in communication with the inlet channel. The optical channel is in communication with the outlet pipe.

In another aspect, the outlet assembly includes a receiving bore. The inlet assembly includes an interconnection channel. The light guide includes an aperture located between the outlet assembly and the operation assembly. The operation assembly includes a cylinder, an optical pipe, a casing, a seat and an interconnection pipe. The cylinder includes a space and an aperture in communication with the space. The optical pipe is formed with the optical channel. The optical pipe includes an upper portion, a middle portion and a lower portion. The upper portion is inserted in the receiving bore of the outlet assembly. The middle portion is inserted in the aperture of the light guide. The lower portion is inserted in the aperture of the cylinder. The casing is formed with the operation chamber and fitted in the space of the cylinder, below the optical pipe. The seat is formed with the cave and fitted in the space of the cylinder, below the casing. The interconnection pipe is formed with the interconnecting channel. The interconnection pipe includes a first portion connected to the seat and a second portion fitted in the interconnection channel of the inlet assembly. The interconnecting channel of the interconnection pipe is in communication with the cave of the seat and the inlet channel of the inlet assembly.

In another aspect, the water-proof light-emitting module includes a water-proof shell, a circuit board located in the water-proof shell, and a bundle of cables that is connected to the circuit board and extends out of the water-proof shell. The water-proof shell includes an optical exit aligned with the first open end of the operation chamber. The circuit board includes an ultraviolet light-emitting diode for emitting the ultraviolet light and a visible light light-emitting diode for emitting the visible light. The ultraviolet light and the visible light go out of the water-proof shell through the optical exit.

In another aspect, the seat includes a cable aperture. The inlet assembly including a cable channel. The bundle of cables of the water-proof light-emitting module extends through the cable aperture of the seat and the cable channel of the inlet assembly.

In another aspect, the seat includes hooks pointed at the casing, located around the water-proof shell of the water-proof light-emitting module, and engaged with the optical exit of the water-proof shell.

In another aspect, the casing includes protrusive portions extending from a lower face. The protrusive portions gaps are located around the first open end of the operation chamber and supported on the optical exit of the water-proof shell of the water-proof light-emitting module.

In another aspect, each of the protrusive portions includes an end inserted in the first open end of the operation chamber.

In another aspect, the ultraviolet light-emitting faucet includes a sensor connected to the water-proof light-emitting module. The sensor commands the water-proof light-emitting module to emit the ultraviolet light and the visible light when water is allowed to go out of the outlet pipe. The sensor commands the water-proof light-emitting module to stop emitting any light when water is not allowed to go out of the outlet pipe.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of an ultraviolet light-emitting faucet according to the preferred embodiment of the present invention;

FIG. 2 is a cross-sectional view of the ultraviolet light-emitting faucet shown in FIG. 1;

FIG. 3 is an exploded view of the ultraviolet light-emitting faucet shown in FIG. 1;

FIG. 4 is a cross-sectional view of a seat of the ultraviolet light-emitting faucet shown in FIG. 1;

FIG. 5 is a perspective view of a casing of the ultraviolet light-emitting faucet shown in FIG. 1;

FIG. 6 is a cross-sectional view of the ultraviolet light-emitting faucet shown in FIG. 5;

FIG. 7 is a bottom view of the casing shown in FIG.5; and

FIG. 8 is a cross-sectional view of an operation assembly of the ultraviolet light-emitting faucet shown in FIG. 1.

### DETAILED DESCRIPTION OF PREFERRED EMBODIMENT

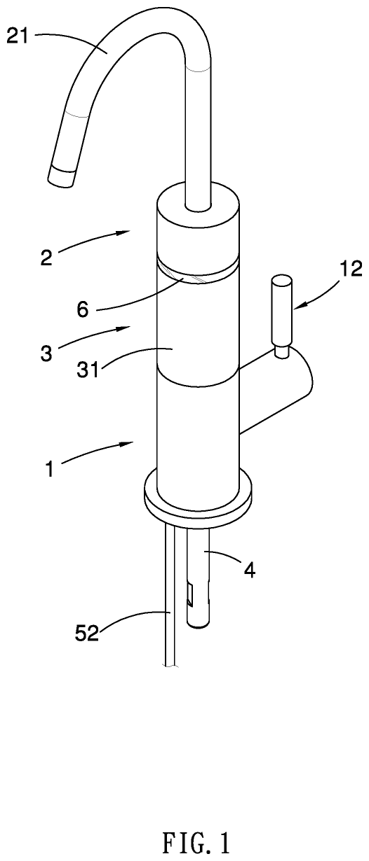

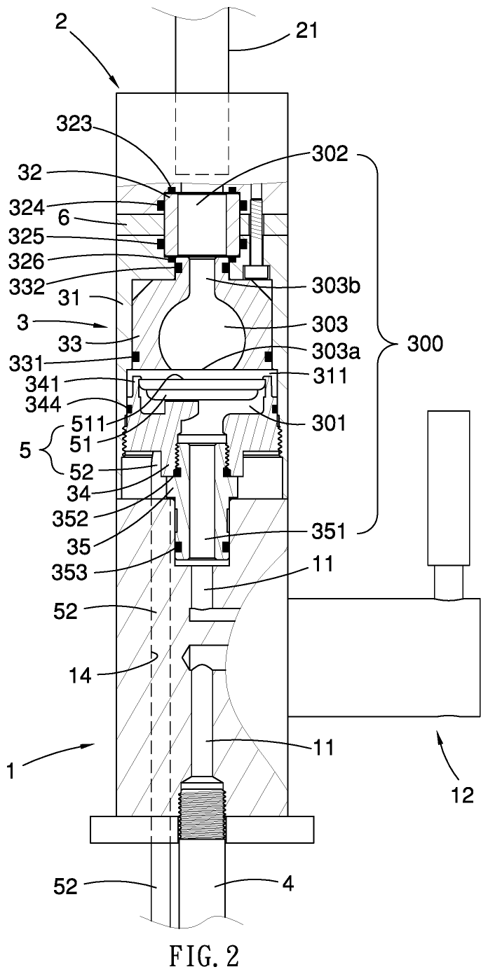

Referring to FIGS. 1 and 2, an ultraviolet light-emitting faucet includes an inlet assembly 1, an outlet assembly 2 and an operation assembly 3 for connecting the inlet assembly 1 to the outlet assembly 2 according to the preferred embodiment of the present invention. The inlet assembly 1 includes an inlet channel 11 through which water enters the inlet assembly 1. The outlet assembly 2 includes an outlet pipe 21 via which water goes out of the outlet assembly 2. Preferably, the inlet assembly 1 is connected to an inlet pipe 4 by engagement of threads so that water is transmitted into the inlet channel 11 from the inlet pipe 4. Preferably, the inlet assembly 1 further includes a maneuver set 12 operable to control the opening and closing of the inlet channel 11 to determine whether to allow water to go through the outlet pipe 21.

Referring to FIG. 2, the operation assembly 3 includes a conduit 300. In the preferred embodiment, the conduit 300 includes an axial channel 351 in communication with the inlet channel 11 of the inlet assembly 1, a cave 301 in communication with the axial channel 351, an optical channel 302 in communication with the outlet pipe 21 of the outlet assembly 2, and an operation chamber 303 located between the cave 301 and the optical channel 302. The operation chamber 303 includes a first open end 303 and a second open end 303b. The first open end 303a is in communication with the cave 301. The second open end 303b is in communication with the optical channel 302. Thus, the water that enters the inlet assembly 1 from the inlet pipe 4 goes sequentially through the inlet channel 11 of the inlet assembly 1 and the conduit 300 of the operation assembly 3, and then goes to the exterior from the ultraviolet light-emitting faucet via the outlet pipe 21 of the outlet assembly 2.

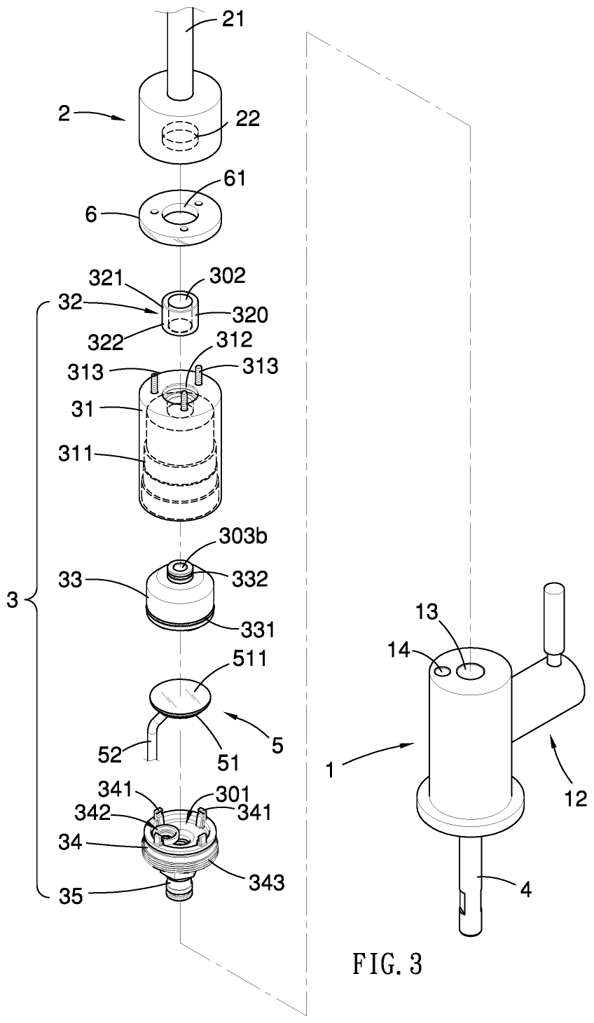

Referring to FIGS. 2 and 3, the ultraviolet light-emitting faucet further includes a water-proof light-emitting module 5 located in the cave 301 of the operation assembly 3 and a light guide 6 located in the operation assembly 3. The water-proof light-emitting module 5 casts ultraviolet light and visible light into the operation chamber 303 through the first open end 303a. The ultraviolet light that is cast into the operation chamber 303 irradiates the water contained in the operation chamber 303 for sterilization. The visible light that is cast into the operation chamber 303 advances into the optical channel 302 through the second open end 303b of the operation chamber 303. The light guide 6 is located on the operation assembly 3, and operated to guide the visible light that is cast into the optical channel 302 to the exterior so that the visible light is observed by people. Preferably, the visible light can be in red, orange, blue, green or purple for example, or in multiple colors.

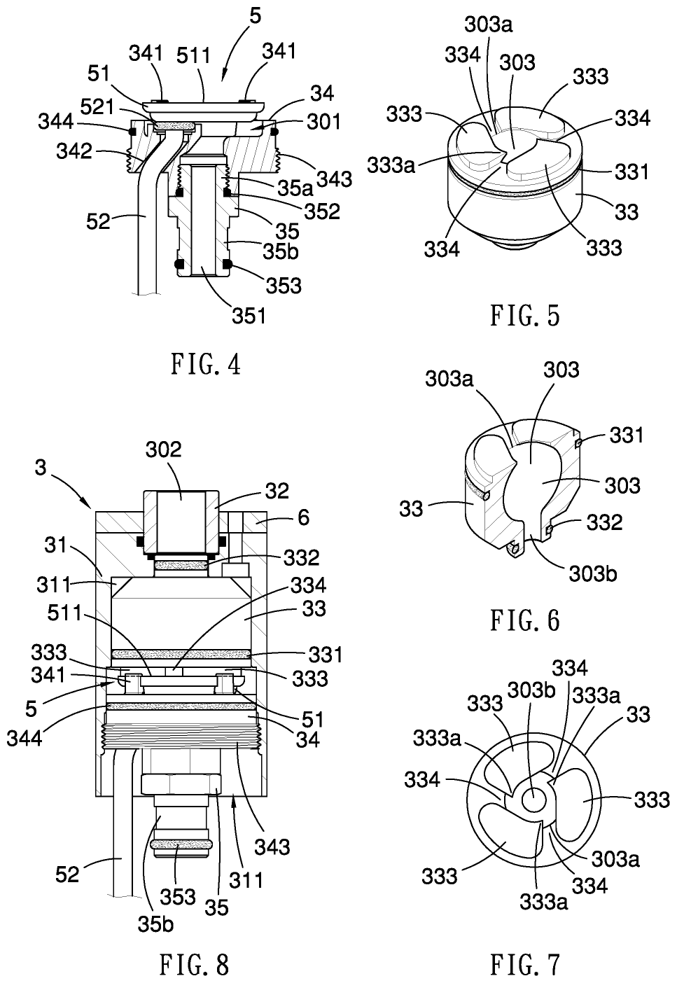

In the preferred embodiment, referring to FIGS. 3 and 4, the water-proof light-emitting module 5 includes a water-proof shell 51, a circuit board (not shown) located in the water-proof shell 51, and a bundle of cables 52 that is connected to the circuit board and extends out of the water-proof shell 51. The water-proof shell 51 includes an optical exit 511 aligned with the first open end 303a of the operation chamber 303. The circuit board is formed with a circuit. The circuit includes an ultraviolet light-emitting diode for emitting the ultraviolet light and a visible light light-emitting diode for emitting the visible light. The ultraviolet light and the visible light go out of the water-proof shell 51 through the optical exit 511, and enter the operation chamber 303 via the first open end 303a. The bundle of cables 52 transmits power or signals.

Referring to FIGS. 2 and 6, the operation chamber 303 is preferably a spherical chamber. The wall of the operation 303 is a spherical face that reflects the ultraviolet light several times in the operation chamber 303 to increase the sterilization of the water in the operation chamber 303.

Referring to FIGS. 2 and 3, in the preferred embodiment, the outlet assembly 2 includes a receiving bore 22, the inlet assembly 1 includes an interconnection channel 13, and the light guide 6 includes an aperture 61 and is located between the outlet assembly 2 and the operation assembly 1. The operation assembly 3 further includes an optical pipe 32, a casing 33, a seat 34 and an interconnection pipe 35. The optical pipe 32 is formed with the optical channel 302. The casing 33 is formed with the operation chamber 303. The seat 34 is formed with the cave 301. The interconnection pipe 35 is formed with the axial channel 351.

The cylinder 31 includes a space 311 and an aperture 312 in communication with the space 311. In the preferred embodiment, several threaded bolts 313 vertically extend throughout the cylinder 31, extend out of the light guide 6, and extends into screw holes (not numbered) in the outlet assembly 2, thereby keeping the light guide 6 between the cylinder 31 and the outlet assembly 2. Moreover, the light guide 6 includes an aperture 61. Preferably, the inlet assembly 1, the outlet assembly 2 and the cylinder 31 of the operation assembly 3 are made of metal such as copper and stainless steel for example.

The visible light is allowed to go through the optical pipe 32 and the light guide 6. Preferably, the optical pipe 32 and the light guide 6 are made of a transparent material such as glass and acrylic. Moreover, the optical pipe 32 includes an upper portion 321 inserted in the receiving bore 22 of the outlet assembly 2, a middle portion 320 inserted in the aperture 61 of the light guide 6, and a lower portion 322 inserted in the aperture 312 of the cylinder 31. To avoid leak, there are preferably several annular seals 323 and 324 between the upper portion 321 of the optical pipe 32 and the receiving bore 22 of the outlet assembly 2, and several annular seals 325 and 326 between the lower portion 322 of the optical pipe 32 and the aperture 312 of the cylinder 31. Furthermore, the optical pipe 32 and the light guide 6 can be made in one piece. However, the middle portion 320 of the optical pipe 32 is preferably made of glass, and the light guide 6 is preferably made of transparent acrylic.

The casing 33 and the cylinder 31 can be made in one piece or as two separate elements. In the preferred embodiment, the casing 33 is made independent of the cylinder 31 and is fitted in the space 311 of the cylinder 31, below the optical pipe 32. The casing 33 is made of Teflon for example. In addition, to avoid leak, there are several annular seals 331 and 332 between the cylinder 31 of the casing 33 and the space 311.

Referring to FIGS. 5 through 8, in the preferred embodiment, the casing 33 includes protrusive portions 333 extending from a lower face. The protrusive portions 333 are separated from one another by gaps and located around the first open end 303 of the operation chamber 303. The protrusive portions 333 are located in the optical exit 511 of the water-proof shell 51 of the water-proof light-emitting module 5. Preferably, each of the protrusive portions 333 includes an end 333a inserted in the first open end 303a of the operation chamber 303. Moreover, it should be noted that the protrusive portions 333 are omitted from FIG. 2.

Referring to FIGS. 2 through 4, the seat 34 is fitted in the space 311 of the cylinder 31, below the casing 33. In the preferred embodiment, the seat 34 includes a thread 343 engaged with a thread (not numbered) of the cylinder 31. Furthermore, to avoid leak, there is an annular seal 344 between the seat 34 and the cylinder 31.

In the preferred embodiment, the interconnection pipe 35 includes a first portion 35a connected to the seat 34 by engagement of threads. The interconnection pipe 35 includes a second portion 35b fitted in the interconnection channel 13 of the inlet assembly 1. The axial channel 351 of the interconnection pipe 35 is in communication with the cave 301 of the seat 34 and the inlet channel 11 of the inlet assembly 1. Moreover, to avoid leak, there is an annular seal 352 between the first portion 35a of the interconnection pipe 35 and the seat 34, and there is an annular seal 353 between the second portion 35b of the interconnection pipe 35 and the interconnection channel 13 of the inlet assembly 1.

Preferably, the seat 34 further includes hooks 341 pointed at the casing 33. The hooks 341 are separated from one another by gaps and located around the water-proof shell 51 of the water-proof light-emitting module 5. The hooks 341 hook an edge of the optical exit 511 of the water-proof shell 51. Preferably, the seat 51 further includes a cable aperture 342, the inlet assembly 1 includes a cable channel 14. The bundle of cables 52 of the water-proof light-emitting module 5 extends through the cable aperture 342 of the seat 34 and the cable channel 14 of the inlet assembly 1. Preferably, the seat 34 is made of a plastic material such as polyoxymethylene (“POM”). The interconnection pipe 35 can be made of metal such as copper and stainless. Alternatively, the interconnection pipe 35 can be made of a plastic material such as POM. Furthermore, to avoid leak, there is an annular seal 521 between the cable 52 and the cable aperture 342 of the seat 34.

Referring to FIGS. 2, 4 and 8, in the preferred embodiment, the water in the inlet pipe 4 sequentially goes through the inlet channel 11 of the inlet assembly 1, the axial channel 351 of the interconnection pipe 35, the cave 301 of the seat 34, the gaps between the hooks 341 of the seat 34, the space 311 of the cylinder 31 (between the casing 33 and the seat 34), the gaps 334 between the protrusive portions 333 of the casing 33, the first open end 303a, the operation chamber 303, the second open end 303b and the optical channel 302 of the optical pipe 32, and then reaches the exterior from via the outlet pipe 21 of the outlet assembly 2. The water that travels in the operation chamber 303 of the casing 33 is irradiated by the ultraviolet light and sterilized.

Preferably, the ultraviolet light-emitting faucet further includes a sensor (not shown). The sensor is connected to the circuit of the water-proof light-emitting module 5 via the bundle of cables 52. The sensor orders the water-proof light-emitting module 5 to emit the ultraviolet light and the visible light when the water leaves the outlet pipe 21. The sensor orders the water-proof light-emitting module 5 to stop emitting the ultraviolet light and the visible light when water is not allowed to leave the outlet pipe 21. For example, the sensor can be a water-pressure sensor located I the inlet pipe 4. On detecting that water enters the ultraviolet light-emitting faucet, the water-pressure sensor actuates the circuit to emit the ultraviolet light and the visible light. Alternatively, the sensor can be a touch sensor located in or on the maneuver set 12. On detecting that the maneuver set 12 is touched, the touch sensor actuates the circuit to emit the ultraviolet light and the visible light. Alternatively, the sensor can be a position sensor located in or on the maneuver set 12. On detecting that the maneuver set 12 is maneuvered to move the ultraviolet light-emitting faucet to an open position, the position sensor actuates the circuit to emit the ultraviolet light and the visible light.

In another embodiment, the axial channel 351 of the operation assembly 3 is in communication with the outlet pipe 21 of the outlet assembly 2, and the optical channel 302 is in communication with the inlet channel 11 of the inlet assembly 1. That is, the operation assembly 3 is inverted.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. An ultraviolet light-emitting faucet comprising:
an inlet assembly comprising an inlet channel;
an outlet assembly comprising an outlet pipe; and
an operation assembly comprising a conduit for connecting the inlet channel to the outlet channel, and the conduit comprising:
an interconnecting channel;
a cave in communication with the interconnecting channel;
an optical channel; and
an operation chamber comprising a first open end in communication with the cave and a second open end in communication with the optical channel;
a water-proof light-emitting module located in the cave of the operation assembly and operable to cast ultraviolet light and visible light into the operation chamber through the first open end of the operation chamber of the operation assembly, wherein the visible light further goes into the optical channel through the second open end of the operation chamber of the operation assembly; and
a light guide supported on the operation assembly and operable to guide the visible light out of the optical channel.

2. The ultraviolet light-emitting faucet according to claim 1, wherein the water-proof light-emitting module comprises a water-proof shell, a circuit board located in the water-proof shell, and a bundle of cables that is connected to the circuit board and extends out of the water-proof shell, wherein the water-proof shell comprises an optical exit aligned with the first open end of the operation chamber, the circuit board comprises an ultraviolet light-emitting diode for emitting the ultraviolet light and a visible light light-emitting diode for emitting the visible light, and the ultraviolet light and the visible light go out of the water-proof shell through the optical exit.

3. The ultraviolet light-emitting faucet according to claim 1, wherein the operation chamber is a spherical chamber.

4. The ultraviolet light-emitting faucet according to claim 1, wherein the interconnecting channel of the operation assembly is in communication with the inlet channel, and the optical channel is in communication with the outlet pipe.

5. The ultraviolet light-emitting faucet according to claim 4, wherein the outlet assembly comprises a receiving bore, the inlet assembly comprises an interconnection channel, the light guide comprises an aperture located between the outlet assembly and the operation assembly, and the operation assembly comprises:
a cylinder comprising a space and an aperture in communication with the space;
an optical pipe formed with the optical channel, wherein the optical pipe comprises:
an upper portion inserted in the receiving bore of the outlet assembly;
a middle portion inserted in the aperture of the light guide; and
a lower portion inserted in the aperture of the cylinder;
a casing formed with the operation chamber and fitted in the space of the cylinder, below the optical pipe;
a seat formed with the cave and fitted in the space of the cylinder, below the casing; and
an interconnection pipe formed with the interconnecting channel, wherein the interconnection pipe comprises a first portion connected to the seat and a second portion fitted in the interconnection channel of the inlet assembly, and the interconnecting channel of the interconnection pipe is in communication with the cave of the seat and the inlet channel of the inlet assembly.

6. The ultraviolet light-emitting faucet according to claim 5, wherein the water-proof light-emitting module comprises a water-proof shell, a circuit board located in the water-proof shell, and a bundle of cables that is connected to the circuit board and extends out of the water-proof shell, and the water-proof shell comprises an optical exit aligned with the first open end of the operation chamber, the circuit board comprises an ultraviolet light-emitting diode for emitting the ultraviolet light and a visible light light-emitting diode for emitting the visible light, and the ultraviolet light and the visible light go out of the water-proof shell through the optical exit.

7. The ultraviolet light-emitting faucet according to claim 6, wherein the seat comprises a cable aperture, the inlet assembly comprising a cable channel, the bundle of cables of the water-proof light-emitting module extends through the cable aperture of the seat and the cable channel of the inlet assembly.

8. The ultraviolet light-emitting faucet according to claim 7, wherein the seat comprises hooks pointed at the casing, located around the water-proof shell of the water-proof light-emitting module, and engaged with the optical exit of the water-proof shell.

9. The ultraviolet light-emitting faucet according to claim 5, wherein the casing comprises protrusive portions extending from a lower face, the protrusive portions gaps are located around the first open end of the operation chamber and supported on the optical exit of the water-proof shell of the water-proof light-emitting module.

10. The ultraviolet light-emitting faucet according to claim 9, wherein each of the protrusive portions comprises an end inserted in the first open end of the operation chamber.

11. The ultraviolet light-emitting faucet according to claim 1, comprising a sensor connected to the water-proof light-emitting module, and operable to command the water-proof light-emitting module to emit the ultraviolet light and the visible light when water is allowed to go out of the outlet pipe, and command the water-proof light-emitting module to stop emitting any light when water is not allowed to go out of the outlet pipe.
